(19) United States
(12) Patent Application Publication
(10) Pub. No.: US 2023/0098238 A1
(43) Pub. Date: Mar. 30, 2023

(54) DETECTION AND MANAGEMENT OF DYSFUNCTIONS IN SUBTERRANEAN OPERATIONS

(71) Applicant: Nabors Drilling Technologies USA, Inc., Houston, TX (US)

(72) Inventors: Malini MANOCHA, Cypress, TX (US); Pradeep ANNAIYAPPA, Houston, TX (US)

(21) Appl. No.: 17/934,591

(22) Filed: Sep. 23, 2022

Related U.S. Application Data
(60) Provisional application No. 63/261,816, filed on Sep. 29, 2021.

(51) Int. Cl. G06Q 10/06

(52) U.S. Cl. CPC G06Q 10/06312; G06Q 10/0637; G06Q 10/0639

(57) ABSTRACT

A method that can include receiving a digital well plan comprising tool non-specific operations, converting the digital well plan to a digital rig plan, the digital rig plan comprising a plurality of first task lists of tool-specific tasks for a specific rig, with each one of the plurality of first task lists performing at least one of the tool non-specific operations, inserting into the digital rig plan, via a rig controller, at least one alternative list of tool-specific tasks for performing at least one alternative operation, during execution of the digital rig plan, selecting, via the rig controller, the at least one alternative list of tool-specific tasks, and performing, at the rig, the at least one alternative list of tool-specific tasks in response to the selecting.

### CROSS-REFERENCE TO RELATED APPLICATION(S)

This application claims priority under 35 U.S.C. § 119(e) to U.S. Patent Application No. 63/261,816, entitled “DETECTION AND MANAGEMENT OF DYSFUNCTIONS IN SUBTERRANEAN OPERATIONS,” by Malini MANOCHA et al., filed Sep. 29, 2021, which application is assigned to the current assignee hereof and incorporated herein by reference in its entirety.

### TECHNICAL FIELD

The present invention relates, in general, to the field of drilling and processing of wells. More particularly, present embodiments relate to a system and method for detecting and managing dysfunctions in a subterranean operation, such as drilling and processing of a well.

### BACKGROUND

During well construction operations, activities on a rig can be organized according to a well plan. The well plan can be converted to a rig plan (i.e., rig specific well construction plan) for implementation on a specific rig. Deviations from the well plan or rig plan can cause rig delays, increase well site operation costs, and cause other impacts to operations. Delays in identifying the deviations can exacerbate these impacts. Therefore, improvements in rig activity monitoring and reporting are continually needed.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for performing a subterranean operation. The method also includes receiving, at the rig controller, a digital well plan may include tool non-specific operations; converting the digital well plan to a digital rig plan, the digital rig plan may include a plurality of first task lists of tool-specific tasks for a specific rig, with each one of the plurality of first task lists performing at least one of the tool non-specific operations; inserting into the digital rig plan, via a rig controller, at least one alternative list of tool-specific tasks for performing at least one alternative operation; during execution of the digital rig plan, selecting, via the rig controller, the at least one alternative list of tool-specific tasks; and performing, at the rig, the at least one alternative list of tool-specific tasks in response to the selecting. Other embodiments of this aspect include corresponding computer systems, apparatus, and computer programs recorded on one or more computer storage devices, each configured to perform the actions of the methods.

One general aspect includes a method for performing a subterranean operation. The method also includes receiving, at the rig controller, a digital well plan that may include a set of rig activities for a rig; retrieving a set of sequence blocks from a rig activity database for each of the rig activities, where each sequence block may include a set of operations to be performed to execute the sequence block, and where at least one of the sequence blocks may include a first alternative set of operations which is selectable during execution of the digital well plan; receiving, at a rig controller, a rig type of the rig; retrieving, via the rig controller, a set of rig equipment from a rig equipment database based on the rig type; retrieving a first task list of tool-specific tasks for each piece of rig equipment in the set of rig equipment, thereby creating a plurality of first task lists; and converting the sequence blocks of the digital well plan to a digital rig plan that may include a second task list of tool-specific tasks to implement the digital well plan, where the second task list may include a listing of the plurality of first task lists, and where the plurality of first tasks lists may include one or more third task lists to implement the first alternative set of operations. Other embodiments of this aspect include corresponding computer systems, apparatus, and computer programs recorded on one or more computer storage devices, each configured to perform the actions of the methods.

### BRIEF DESCRIPTION OF THE DRAWINGS

These and other features, aspects, and advantages of present embodiments will become better understood when the following detailed description is read with reference to the accompanying drawings in which like characters represent like parts throughout the drawings, wherein:

FIG. 1A is a representative simplified front view of a rig being utilized for a subterranean operation, in accordance with certain embodiments;

FIG. 1B is a representative simplified view of an individual (or user) using wearable devices for user input or identification, in accordance with certain embodiments;

FIG. 2 is a representative partial cross-sectional view of a rig being utilized for a subterranean operation, in accordance with certain embodiments;

FIG. 3 is a representative front view of various individuals identifiable via an imaging system, in accordance with certain embodiments;

FIG. 4A is a representative list of activities for an example digital well plan, in accordance with certain embodiments;

FIG. 4B is a representative functional diagram that illustrates the conversion of well plan activities to rig plan tasks, in accordance with certain embodiments;

FIG. 5 is a representative functional diagram that illustrates possible databases used by a rig controller to convert a digital well plan to a digital rig plan, in accordance with certain embodiments;

FIG. 6 is a representative functional diagram that illustrates converting a digital well plan to a digital rig plan and mitigating a detected dysfunction while executing the digital rig plan, in accordance with certain embodiments; and

FIG. 7 is a representative functional diagram that illustrates using a rip plan engine and databases to convert a digital well plan to a digital rig plan, with the digital well plan including alternate activities for managing a dysfunction, in accordance with certain embodiments.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about”, “approximately”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described. A significant difference can be when the difference is greater than ten percent (10%).

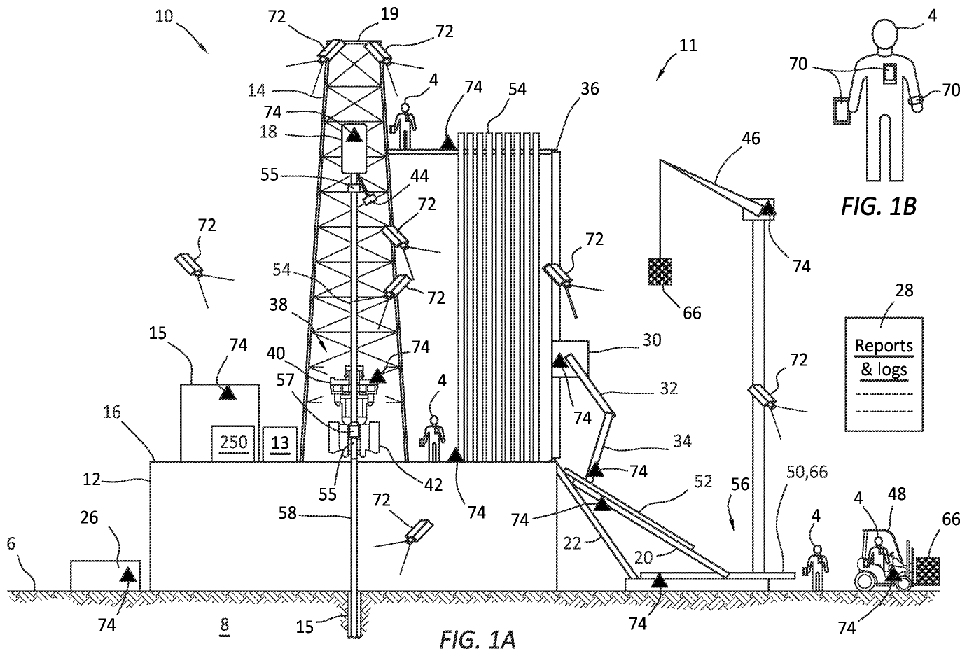

As used herein, “tubular” refers to an elongated cylindrical tube and can include any of the tubulars manipulated around a rig, such as tubular segments, tubular stands, tubulars, and tubular string, but not limited to the tubulars shown in FIG. 1A. Therefore, in this disclosure, “tubular” is synonymous with “tubular segment,” “tubular stand,” and “tubular string,” as well as “pipe,” “pipe segment,” “pipe stand,” “pipe string,” “casing,” “casing segment,” or “casing string.”

FIG. 1A is a representative simplified front view of a rig 10 at a rig site 11 being utilized for a subterranean operation (e.g., tripping in or out a tubular string to or from a wellbore), in accordance with certain embodiments. The rig site 11 can include the rig 10 with its rig equipment, along with all support equipment and work areas that support the rig 10 but are not necessarily on the rig 10. The rig 10 can include a platform 12 with a rig floor 16 and a derrick 14 extending up from the rig floor 16. The derrick 14 can provide support for hoisting the top drive 18 as needed to manipulate tubulars. A catwalk 20 and V-door ramp 22 can be used to transfer horizontally stored tubular segments 50 to the rig floor 16. A tubular segment 52 can be one of the horizontally stored tubular segments 50 that is being transferred to the rig floor 16 via the catwalk 20. A pipe handler 30 with articulating arms 32, 34 can be used to grab the tubular segment 52 from the catwalk 20 and transfer the tubular segment 52 to the top drive 18, the fingerboard 36, the wellbore 15, etc. However, it is not required that a pipe handler 30 be used on the rig 10. The top drive 18 can transfer tubulars directly to and directly from the catwalk 20 (e.g., using an elevator coupled to the top drive).

The tubular string 58 can extend into the wellbore 15, with the wellbore 15 extending through the surface 6 into the subterranean formation 8. When tripping the tubular string 58 into the wellbore 15, tubulars 54 are sequentially added to the tubular string 58 to extend the length of the tubular string 58 into the earthen formation 8. FIG. 1A shows a land-based rig. However, it should be understood that the principles of this disclosure are equally applicable to off-shore rigs where “off-shore” refers to a rig with water between the rig floor and the earth surface 6.

When tripping the tubular string 58 out of the wellbore 15, tubulars 54 are sequentially removed from the tubular string 58 to reduce the length of the tubular string 58 in the wellbore 15. The pipe handler 30 can be used to remove the tubulars 54 from an iron roughneck 38 or a top drive 18 at a well center 24 and transfer the tubulars 54 to the catwalk 20, the fingerboard 36, etc. The iron roughneck 38 can break a threaded connection between a tubular 54 being removed and the tubular string 58. A spinner assembly 40 can engage a body of the tubular 54 to spin a pin end 57 of the tubular 54 out of a threaded box end 55 of the tubular string 58, thereby unthreading the tubular 54 from the tubular string 58.

When tripping the tubular string 58 into the wellbore 15, tubulars 54 are sequentially added to the tubular string 58 to increase the length of the tubular string 58 in the wellbore 15. The pipe handler 30 can be used to deliver the tubulars 54 to a well center on the rig floor 16 in a vertical orientation and hand the tubulars 54 off to an iron roughneck 38 or a top drive 18. The iron roughneck 38 can make a threaded connection between the tubular 54 being added and the tubular string 58. A spinner assembly 40 can engage a body of the tubular 54 to spin a pin end 57 of the tubular 54 into a threaded box end 55 of the tubular string 58, thereby threading the tubular 54 into the tubular string 58. The wrench assembly 42 can provide a desired torque to the threaded connection, thereby completing the connection.

While tripping a tubular string into and out of the wellbore 15 can be a significant part of the operations performed by the rig, many other well plan activities are also needed to perform a well construction according to a digital well plan. For example, pumping mud at desired rates, maintaining downhole pressures (as in managed pressure drilling), maintaining, and controlling rig power systems, coordinating, and managing personnel on the rig during operations, performing pressure tests on sections of the wellbore 15, cementing a casing string in the wellbore, performing well logging operations, as well as many other well plan activities. As used herein, a “digital well plan” refers to a list of activities to be performed to construct a specific wellbore 15 in an earthen formation 8. As used herein, a “digital rig plan” refers to a list of rig-specific tasks to be performed to execute the digital well plan on a specific rig.

A rig controller 250 can be used to control the rig 10 operations including controlling various rig equipment, such as the pipe handler 30, the top drive 18, the iron roughneck 38, the fingerboard equipment, imaging systems, various other robots on the rig 10 (e.g., a drill floor robot), or rig power systems 26. The rig controller 250 can control the rig equipment autonomously (e.g., without periodic operator interaction), semi-autonomously (e.g., with limited operator interaction such as initiating a subterranean operation, adjusting parameters during the operation, etc.), or manually (e.g., with the operator interactively controlling the rig equipment via remote control interfaces to perform the subterranean operation).

The rig controller 250 can include one or more processors with one or more of the processors distributed about the rig 10, such as in an operator's control hut, in the pipe handler 30, in the iron roughneck 38, in the vertical storage area 36, in the imaging systems, in various other robots, in the top drive 18, at various locations on the rig floor 16 or the derrick 14 or the platform 12, at a remote location off of the rig 10, at downhole locations, etc. It should be understood that any of these processors can perform control or calculations locally or can communicate to a remotely located processor for performing the control or calculations. Each of the processors can be communicatively coupled to a non-transitory memory, which can include instructions for the respective processor to read and execute to implement the desired control function. These processors can be coupled via a wired or wireless network. All data received and sent by the rig controller 250 is in a computer-readable format and can be stored in and retrieved from the non-transitory memory.

The rig controller 250 can collect data from various data sources around the rig (e.g., sensors, user input, local rig reports, etc.) and from remote data sources (e.g., suppliers, manufacturers, transporters, company men, remote rig reports, etc.) to monitor and facilitate the execution of a digital well plan. A digital well plan is generally designed to be independent of a specific rig, where a digital rig plan is a digital well plan that has been modified to incorporate the specific equipment available on a specific rig to execute the well plan on the specific rig, such as rig 10. Therefore, the rig controller 250 can be configured to monitor and facilitate the execution of the digital well plan by monitoring and executing the digital rig plan.

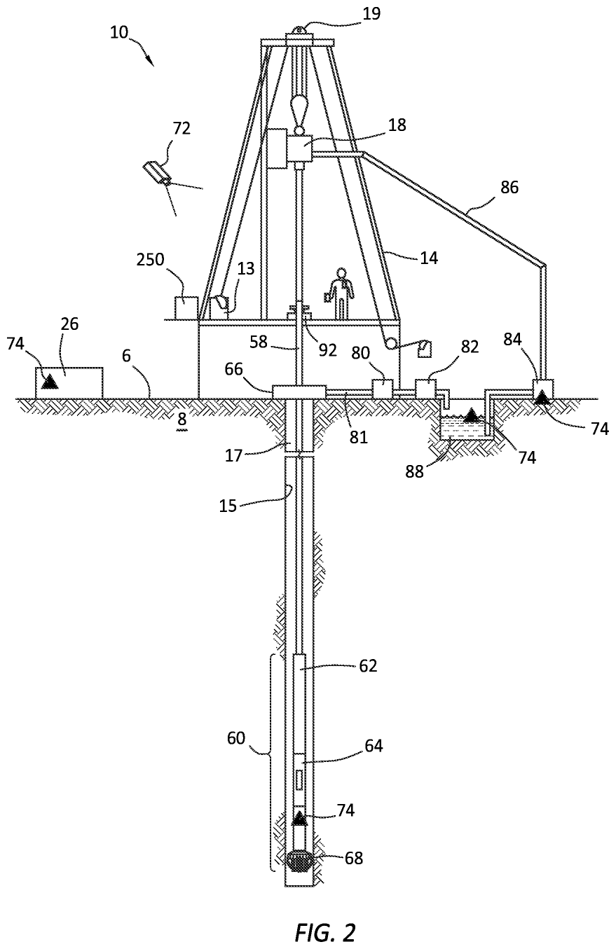

Examples of local data sources are shown in FIG. 1A where an imaging system can include the rig controller 250 and imaging sensors 72 positioned at desired locations around the rig and around support equipment/material areas, such as mud pumps (see FIG. 2), horizontal storage area 56, power system 26, etc., to collect imagery of the desired locations. Also, various sensors 74 can be positioned at various locations around the rig 10 and the support equipment/material areas to collect information from the rig equipment (e.g., pipe handler 30, roughneck 38, top drive 18, vertical storage 36, etc.) and support equipment (e.g., crane 46, forklift 48, horizontal storage area 56, power system 26, etc.) to collect operational parameters of the equipment. Additional information can be collected from other data sources, such as reports and logs 28 (e.g., tour reports, daily progress reports, reports from remote locations, shipment logs, delivery logs, personnel logs, etc.).

The data sources can also include wearables 70 (e.g., a smart wristwatch, a smart phone, a tablet, a laptop, an identification badge, a wearable transmitter, etc.) that can be worn by an individual 4 (or user 4) to identify the individual 4, deliver instructions to the individual 4, or receive inputs from the individual 4 via the wearable 70 to the rig controller 250 (see FIG. 1B). Network connections (wired or wireless) to the wearables 70 can be used for communication between the rig controller 250 and the wearables 70 for information transfer.

These data sources can be aggregated by the rig controller 250 and used to determine one or more dysfunctions during the execution of the digital well plan. As used herein, a “dysfunction” is an activity at a rig site 11 that causes the rig controller 250 to deviate from the current digital well plan or current digital rig plan. As used herein, the “current digital well plan” or “current well plan” refers to a well plan being executed when the dysfunction is detected (e.g., via analysis of data sources) or otherwise determined (e.g., user input, etc.). As used herein, the “current digital rig plan” or “current rig plan” refers to the rig plan being executed when the dysfunction is detected (e.g., via analysis of data sources) or otherwise determined (e.g., user input, etc.), where the rig plan is an implementation of the well plan on a specific rig (e.g., rig 10).

The dysfunction can be classified into at least three different categories. The dysfunction can be a “planned predictive dysfunction,” an “unplanned predictive dysfunction,” or an “unplanned reactive dysfunction.”

As used herein, a “planned predictive dysfunction” refers to one or more activities at a rig site (e.g., rig site 11) that were included in the digital well plan when the well plan was initially converted to a digital rig plan, but were included as alternative activities in the well plan that can be selected for the execution if an anticipated (or planned) dysfunction is detected. Therefore, the one or more activities for managing the anticipated dysfunction are included in the well plan when it is converted to the rig plan, but the one or more activities can be selected for the execution in the well plan when the anticipated dysfunction is detected, or not selected for the execution in the well plan when the anticipated dysfunction is not detected.

Therefore, the possible need for the one or more activities to be included into the digital well plan (and thus the digital rig plan) was anticipated prior to conversion of the well plan to the rig plan. For example, when the well plan is created, the designer(s) may understand that it is possible (and maybe highly likely) that a fluid loss condition may occur at a certain depth (e.g., such as a salt layer in the earthen formation 8) and that entering this salt layer via a drill string can cause fluid loss to occur. Therefore, the designers may include well activities in the original well plan to handle the anticipated dysfunction (e.g., the fluid loss condition), but the well activities are included as alternative activities to be executed in response to the dysfunction being detected. If the planned dysfunction is not detected, then the well activities may not be executed.

Alternatively, the designers may provide a set of alternative well activities in a well activities database that can later be configured for a specific rig and inserted into the rig plan to handle the anticipated dysfunction if the anticipated dysfunction is detected. In this way, the designers can provide well activities that can manage the anticipated dysfunction without including the activities in the originally converted well plan. The designers can also alternatively, or in addition to, provide a set of rig-specific tasks to be directly inserted into the current digital rig plan to manage the anticipated dysfunction without providing well plan activities that can be converted to rig tasks of a digital rig plan.

As used herein, an “unplanned reactive dysfunction” refers to an unanticipated dysfunction that is detected by the rig controller 250 or individual 4 (local individual 4 being on the rig 10 or remote individual 4 being off the rig 10) and selecting a pre-planned set of rig tasks from a rig task database that can be inserted into the current digital rig plan to manage the unanticipated dysfunction. Alternatively, or in addition to, a pre-planned set of activities from a well plan activities database can be inserted into the current digital well plan and converted to rig-specific tasks to be inserted into the current digital rig plan to manage the unanticipated dysfunction. For example, when a fluid loss condition is detected at a depth that the fluid loss condition was not anticipated, a pre-planned set of rig tasks can be inserted into the current digital rig plan to manage the unanticipated fluid loss that occurs at a certain depth of the wellbore 15.

Additionally, for example, when a fluid kick condition is detected at a certain depth where the fluid kick condition was not anticipated, a pre-planned set of rig tasks can be inserted into the current digital rig plan to manage the unanticipated fluid kick that occurs at a certain depth of the wellbore 15. Additionally, for example, when an equipment failure is detected that directly impacts the execution of the digital well plan, then a pre-planned set of rig tasks can be inserted into the current digital rig plan to manage the unanticipated equipment failure. It should be understood that the pre-planned set of rig tasks can include a pre-planned set of rig tasks created directly by the rig controller 250 or an individual 4, or they can include a pre-planned set of rig tasks that was converted from a pre-planned set of well plan activities to a set of rig specific tasks. For example, if mud pumps 1 and 2 are supporting a drilling operation, but failure of mud pump 2 is detected (i.e., an “unplanned reactive dysfunction”), then rig tasks can be determined and inserted into the digital rig plan 102 to use mud pumps 1 and 3 instead of 1 and 2 to work around the dysfunction.

As used herein, an “unplanned predictive dysfunction” refers to an unanticipated dysfunction that is detected by the rig controller 250 or individual 4 (local individual 4 being on the rig 10 or remote individual 4 being off the rig 10) and the unanticipated dysfunction is determined to occur in the near future. A pre-planned set of rig tasks for managing the unplanned dysfunction can be retrieved, via the rig controller 250, from a rig task database and inserted into the current digital rig plan at an appropriate future time prior to the unplanned dysfunction occurring but does not have to alter the current rig plan immediately. The pre-planned set of rig tasks can be executed at the appropriate time in the future to manage the unanticipated dysfunction that has been predicted to happen in the near future (e.g., within the next week). Since the dysfunction is determined to occur prior to the dysfunction actually occurring, the dysfunction can be seen as being predicted prior to its occurrence. However, the unplanned predictive dysfunction can be seen as a dysfunction that was not highly anticipated or seen as likely to happen at the time the well plan was converted to the rig plan.

Alternatively, or in addition to, a pre-planned set of activities from a well plan activities database can be inserted into the current digital well plan and converted to rig-specific tasks which can be inserted into the current digital rig plan at an appropriate future time prior to the unplanned dysfunction occurring. The unplanned dysfunction can be detected by the rig controller 250 or individual 4 and can be managed at a later time. It does not impact the current execution of the current digital rig plan tasks. For example, when a mud motor status indicates to the rig controller 250 or individual 4 that a future failure of the mud motor is predicted in the near future and that the one or more activities should be inserted into the digital well plan (and thus the digital rig plan) prior to a predicted timeframe of an occurrence of the dysfunction. For example, if mud pumps 1 and 2 are supporting a drilling operation, but a failure of mud pump 2 is predicted in the near future (i.e., an “unplanned predictive dysfunction”), then rig tasks can be determined and inserted into the digital rig plan 102 to use mud pumps 1 and 3 instead of 1 and 2 before mud pump 2 fails but the changes are not needed immediately since the failure is in the near future. Additionally, for example, when secondary activities (that are not included in the well plan activities, but support timely execution of the well activities) are not being completed in a timely fashion (e.g., supply of tubulars running low, mud additives not available for upcoming mud conditioning activity, personnel not available for upcoming required task, etc.), then rig tasks may be added to the current rig plan to facilitate necessary work-arounds for the dysfunctions.

FIG. 2 is a representative partial cross-sectional view of a rig 10 being used to drill a wellbore 15 in an earthen formation 8. FIG. 2 shows a land-based rig, but the principles of this disclosure can equally apply to off-shore rigs, as well. The rig 10 can include a top drive 18 with a traveling block 19 and drawworks 13 used to raise or lower the top drive 18. A derrick 14 extending from the rig floor, can provide the structural support of the rig equipment for performing subterranean operations (e.g., drilling, treating, completing, producing, testing, etc.). The rig can be used to extend a wellbore 15 through the earthen formation 8 by using a drill string 58 having a Bottom Hole Assembly (BHA) 60 at its lower end. Slips 92 in coordination with the top drive 18 and drawworks 13 can trip in and trip out the tubular string 58. The BHA 60 can include a drill bit 68 and multiple drill collars 62, with one or more of the drill collars including instrumentation 64 for LWD and MWD operations. During drilling operations, drilling mud can be pumped from the surface 6 into the drill string 58 (e.g., via pumps 84 supplying mud to the top drive 18) to cool and lubricate the drill bit 68 and to transport cuttings to the surface via an annulus 17 between the drill string 58 and the wellbore 15.

The returned mud can be directed to the mud pit 88 through the flow line 81 and the shaker 80. A fluid treatment 82 can inject additives as desired to the mud to condition the mud appropriately for the current well activities and possibly future well activities as the mud is being pumped to the mud pit 88. The pump 84 can pull mud from the mud pit 88 and drive it to the top drive 18 to continue circulation of the mud through the drill string 58.

Sensors 74 and imaging sensors 72 can be distributed about the rig and downhole to provide information on the environments in these areas as well as operating conditions, health of equipment, well activity of equipment, fluid properties, WOB, ROP, RPM of drill string, RPM of drill bit 68, etc.

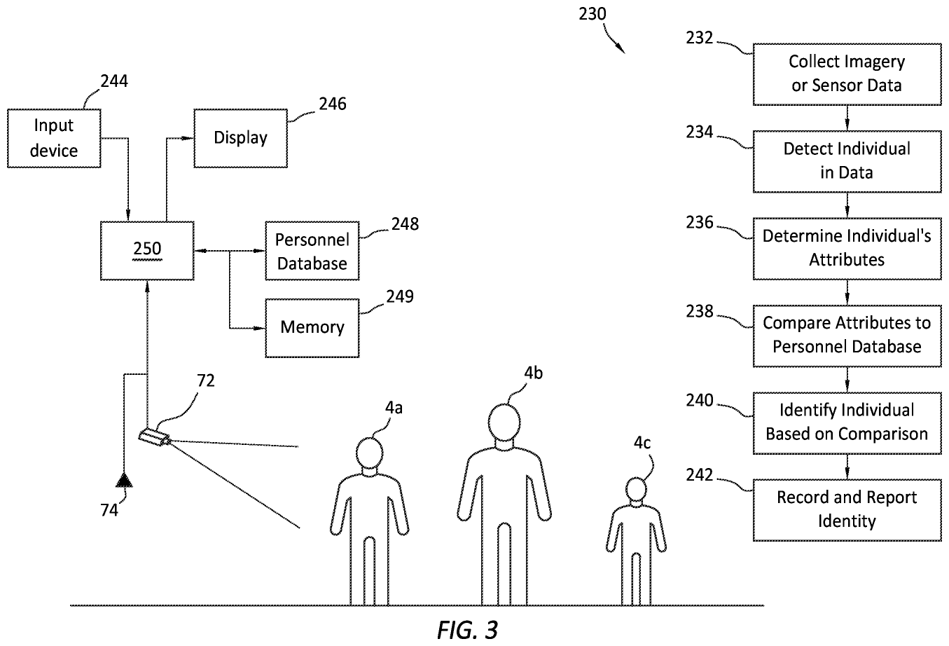

FIG. 3 is a representative front view of various users 4a, 4b, 4c that can be detectable via an imaging system. The imaging system can include the rig controller 250 and one or more imaging sensors 72 and possibly audio sensors 74 as well. When determining the current well activity, it can be beneficial to detect how many individuals are present on the rig, where they are, who they are, and what they are doing. For example, one or more imaging sensors 72 can be used to detect individuals on the rig, track their location as they move about the rig, and determine the identity of each of the individuals. By receiving imagery from the one or more imaging sensors 72, the rig controller 250 can perform image recognition to detect the individuals (such as individuals 4a, 4b, 4c) in the imagery. The rig controller 250 can also determine where each of the individuals are on the rig based on identification of the surroundings around the individuals in the imagery. The rig controller 250 can also determine the identity of each individual by determining attributes of the individual 4, where the attributes can include physical characteristics, mannerisms, walking motion, and voice (e.g., via audio sensors 74 included in the imaging system). The collected data can then be compared against a personnel database 248 to determine the unique identity of each individual 4. The rig controller 250 can record, report, or display the individual's 4 identity. An input device 244 can be used to provide input to the rig controller 250, such as to request identity verification or determination of an individual 4.

The method 230 illustrates a representative flow diagram for using the rig controller 250 to determine an identity of an individual 4 at the rig site. At operation 232, the rig controller 250 can autonomously (or as a result of a user request) collect imagery or other sensor data of one or more individuals 4 at the rig site via the imaging sensor(s) 72 or other sensors 74. At operation 234, the rig controller 250 can detect the one or more individuals in the imagery or sensor data. In operation 236, the rig controller 250 can analyze the imagery or sensor data to determine the attributes of the individual 4. In operation 238, the rig controller 250 can compare the determined attributes to attributes in a personnel database 248. In operation 240, rig controller 250 can identify the individual 4 based on the comparison of the attributes. In operation 242, rig controller 250 can record the individual's identity and report the identity to interested users/individuals. With the identity of each of the individuals determined, the rig controller 250 can compare the actual individuals with the well plan and can use the comparison to improve the confidence level of the estimated well activity.

After determining the unique identity of each individual 4, the rig controller 250 can determine the expertise/skills and experience level of the individual such as from a lookup table stored in non-transitory memory 249 which can be communicatively coupled to the rig controller 250. By knowing the unique identity of the individual, their skill set, and their location on the rig or in support areas, the rig controller 250 can assimilate this information along with the data from other various data sources to better determine the estimated well activity. If the estimated well activity is an expected well activity when compared to the digital well plan, then expected progress is likely being made in executing the digital well plan.

The who and where information of each individual 4 supporting the rig 10 can also be used to verify that the secondary operations are being performed in a timely manner so they do not become a primary activity. As used herein “primary activities” are those activities that are listed in the digital well plan, and as used herein “secondary operations” are those operations that provide support for the execution of the primary activities. Secondary operations can become primary activities if they do not adequately support the primary activities and cause delays in the primary activities by not being able to properly execute the primary activities.

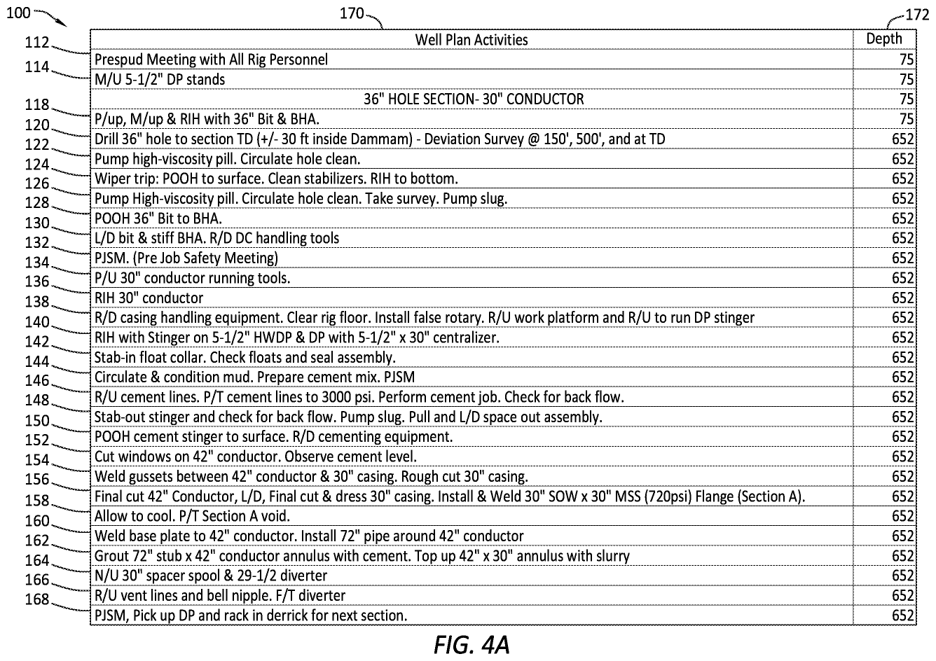

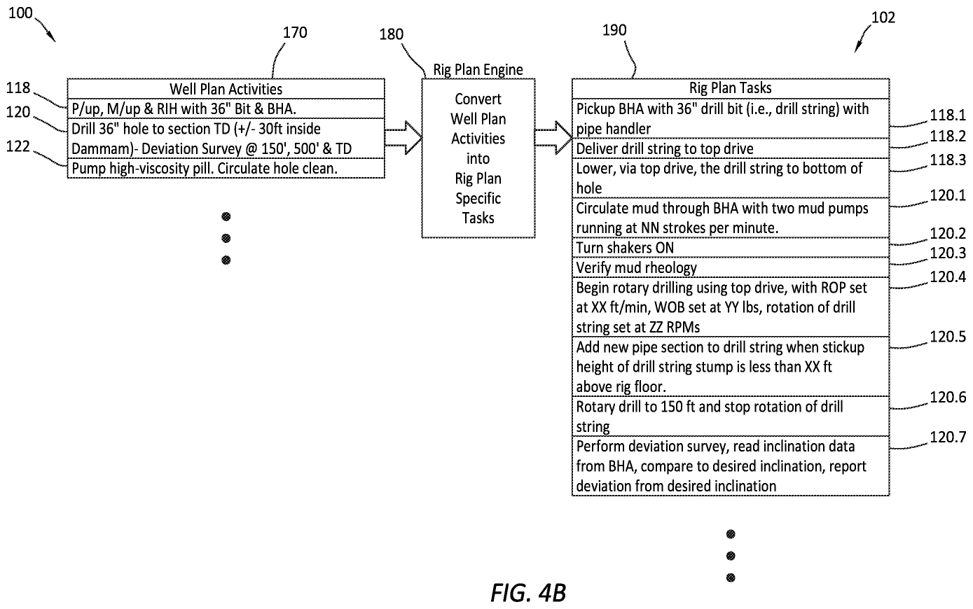

FIG. 4A is a representative list of activities 170 for an example digital well plan 100. This list of well plan activities 170 can merely represent a subset of a complete list of activities needed to execute a full digital well plan 100 to construct a wellbore 15 to a target depth (TD). The digital well plan 100 can include well plan activities 170 with corresponding target wellbore depths 172. However, these specific activities 170 are not required for the digital well plan 100. More or fewer activities 170 can be included in the digital well plan 100 in keeping with the principles of this disclosure. Therefore, the following discussion relating to the well plan activities 170 shown in FIG. 4A is merely an example to illustrate the concepts of this disclosure.

After the rig 10 has been utilized to drill the wellbore 15 to a depth of 75, at activity 112, a Prespud meeting can be held to brief all rig personnel on the goals of the digital well plan 100.

At activity 114, the appropriate personnel and rig equipment can be used to make-up (M/U) 5½″ drill pipe (DP) stands in prep for the upcoming drilling operation. This can for example require a pipe handler and horizontal or vertical storage areas for tubular segments or tubular stands. The primary activities can be seen as the make-up of the drill pipe (DP) stands, with the secondary operations being, for example, availability of tubular segments to build the DP stands; availability of a pipe handler (e.g., pipe handler 30) to manipulate the tubulars; a torquing wrench and backup tong for torquing joints when assembling the DP stands, a horizontal storage area, a vertical storage area; available space in a storage area for the DP stands; doping compound and doping device available for cleaning and doping threads of the tubulars 50; or appropriate personnel to support these operations.

At activity 118, the appropriate personnel and rig equipment can be used to pick up (P/up), makeup (M/up), and run-in hole (RIH) a BHA with a 36″ drill bit 68. This can, for example, require BHA components; a pipe handler to assist in the assembly of the BHA components; a pipe handler to deliver BHA to a top drive; and lowering the top drive to run the BHA into the wellbore 15. The primary activities can be seen as assembling the BHA and lowering the BHA into the wellbore 15. The secondary operations can be delivering the BHA components, including the drill bit, to the rig site; monitoring the health of the equipment to be used; and ensuring personnel available to perform tasks when needed.

At activity 120, the appropriate personnel and rig equipment can be used to drill 36″ hole to a TD of the section, such as 652 ft, to +/−30 ft inside a known formation layer (e.g., Dammam), and performing a deviation survey at depths of 150′, 500′ and TD (i.e., 652′ in this example). The primary activities can be seen as repeatedly feeding tubulars (or tubular stands 54) via a pipe handler to the well center from a tubular storage for connection to a tubular string 58 in the wellbore 15; operating the top drive 18, the iron roughneck 38, and slips to connect tubulars 50 (or tubular stands 54) to the tubular string 58; cleaning and doping threads of the tubulars 50, 54; running mud pumps to circulate mud through the tubular string 58 to the bit 68 and back up the annulus 17 to the surface; running shakers; injecting mud additives to condition the mud; rotating the tubular string 58 or a mud motor (not shown) to drive the drill bit 68, and performing deviation surveys at the desired depths.

The secondary operations can be seen as having tubulars 50 (or tubular stands 54) available in the horizontal storage or vertical storage locations and accessible via the pipe handler. If coming from the horizontal storage 56, then the tubulars 50 can be positioned on horizontal stands, with individuals 4 operating handling equipment, such as forklifts 48 or crane 46, to keep the storage area 56 stocked with the tubulars 50. If coming from the vertical storage 36, then the rig personnel 4 (or rig controller 250), can make sure that enough tubular stands 54 (or tubulars 50) are racked in the vertical storage 36 and accessible to the pipe handler 30 (or another pipe handler if needed). Additional secondary operations can be seen as ensuring that the doping compound and doping device are available for cleaning and doping threads of the tubulars 50; mud additives are available for an individual 4 (e.g., mud engineer) or an automated process to condition the mud as needed; the necessary equipment is available and operational to support the activity 120, such as the top drive 18 (including drawworks), iron roughneck 38, slips, and pipe handlers; and ensuring the power system 26 is configured to support the drilling operation.

At activity 122, the appropriate personnel and rig equipment can be used to pump a high-viscosity pill through the wellbore 15 via the tubular string 58 and then circulate wellbore 15 clean. The primary activities can be seen as injecting mud additives into the mud to create the high-viscosity pill, mud pumps operating to circulate the pill through the wellbore 15 (down through the tubular string 58 and up through the annulus 17); slips to hold tubular string 58 in place; top drive 18 connected to tubular string 58 to circulate mud; and, after pill is circulated, circulating mud through the wellbore 15 to clean the wellbore 15. The secondary operations can be ensuring the power system 26 is configured to support the mud circulation activities; the mud pumps 84 are configured to supply the desired pressure and flow rate of fluid to the tubular string 58; and that the mud additives are available for an individual 4 (e.g., mud engineer) or an automated process to condition the mud as needed.

At activity 124, the appropriate personnel and rig equipment can be used to perform a “wiper trip” by pulling the tubular string 58 out of the hole (Pull out of hole—POOH) to the surface 6; clean stabilizers on the tubular string 58; and run the tubular string 58 back into the hole (Run in hole—RIH) to the bottom of the wellbore 15. The primary activities can be seen as operating the top drive 18, the iron roughneck 38, and slips to disconnect tubulars 50 (or tubular stands 54) from the tubular string 58; moving the tubulars 50 (or tubular stands 54) to vertical storage 36 or horizontal storage 56 via a pipe handler, equipment and personnel/individuals 4 to clean the stabilizers; and operating the top drive 18, the iron roughneck 38, and slips to again connect tubulars 50 (or tubular stands 54) to the tubular string 58 while running the tubular string 58 back into the wellbore 15.

The secondary operations can be seen as having the necessary equipment to support the activity 124 is operational, such as the top drive 18 (including drawworks), iron roughneck 38, slips, and pipe handlers operational; ensuring the power system 26 is configured to support the tripping out and tripping in operations; and ensuring that the appropriate individual(s) 4 and cleaning equipment are available to perform stabilizer cleaning when needed.

At activities 126 thru 168, the appropriate personnel and rig equipment can be used to perform the indicated well plan activities. The primary activities can be seen as the personnel, equipment, or materials needed to directly execute the well plan activities using the specific rig 10. The secondary operations can be those activities that ensure the personnel, equipment, or materials are available and configured to support the primary activities.

FIG. 4B is a functional diagram that can illustrate the conversion of well plan activities 170 to rig plan tasks 190 of a rig-specific digital rig plan 102. When a well plan 100 is designed, well plan activities 170 can be included to describe primary activities needed to construct a desired wellbore 15 to a TD. However, the well plan 100 activities 170 are not specific to a particular rig, such as rig 10. It may not be appropriate to use the well plan activities 170 to direct operations on a specific rig, such as rig 10. Therefore, a conversion of the well plan activities 170 can be performed to create a list of rig plan tasks 190 of a digital rig plan 102 to construct the desired wellbore 15 using a specific rig, such as rig 10. This conversion engine 180 (which can run on a computing system such as the rig controller 250) can take the non-rig specific well plan activities 170 as an input and convert each of the non-rig specific well plan activities 170 to a series of rig specific tasks 190 to create a digital rig plan 102 that can be used to direct activities on a specific rig, such as rig 10, to construct the desired wellbore 15.

As way of example, a high-level description of the conversion engine 180 will be described for a subset of well plan activities 170 to demonstrate a conversion process to create the digital rig plan 102. The well plan activity 118 states, in abbreviated form, to pick up, make up, and run-in hole a BHA 60 with a 36″ drill bit. The conversion engine 180 can convert this single non-rig-specific activity 118 into, for example, three rig-specific tasks 118.1, 118.2, 118.3. Task 118.1 can instruct the rig operators or rig controller 250 to pickup the BHA 60 (which has been outfitted with a 36″ drill bit) with a pipe handler. At task 118.2, the pipe handler can carry the BHA 60 and deliver it to the top drive 18, with the top drive 18 using an elevator to grasp and lift the BHA 60 into a vertical position. At task 118.3, the top drive 18 can lower the BHA 60 into the wellbore 15 which has already been drilled to a depth of 75′ for this example as seen in FIG. 4A. The top drive 18 can lower the BHA 60 to the bottom of the wellbore 15 to have the drill bit 68 in position to begin drilling as indicated in the following well activity 120.

The well plan activity 120 states, in abbreviated form, to drill a 36″ hole to a target depth (TD) of the section, such as 652 ft, to +/−30 ft inside a known formation layer (e.g., Dammam), and performing a deviation survey at depths of 150′, 500′ and TD (i.e., 652′ in this example). The conversion engine 180 can convert this single non-rig-specific activity 120 into, for example, seven rig-specific tasks 120.1 to 120.7. Task 120.1 can instruct the rig operators or rig controller 250 to circulate mud through the top drive 18, through the drill string 58, through the BHA 60, and exiting the drill string 58 through the drill bit 68 into the annulus 17. For this example, the mud flow requires two mud pumps 84 to operate at “NN” strokes per minute, where “NN” is a desired value that delivers the desired mud flow and pressure. At task 120.2, the shaker tables can be turned on in preparation for cuttings that should be coming out of the annulus 17 when the drilling begins. At task 120.3, a mud engineer can verify that the mud characteristics are appropriate for the current tasks of drilling the wellbore 15. If the rheology indicates that mud characteristics should be adjusted, then additives can be added to adjust the mud characteristics as needed.

At task 120.4, rotary drilling can begin by lowering the drill bit into contact with the bottom of the wellbore 15, and rotating the drill bit by rotating the top drive 18 (e.g., rotary drilling). The drilling parameters can be set to be “XX” ft/min for rate of penetration (ROP), “YY” lbs for weight on bit (WOB), and “ZZ” revolutions per minute (RPM) of the drill bit 68.

At task 120.5, as the wellbore 15 is extended by the rotary drilling, when the top end of the tubular string 58 is less than “WW” ft above the rig floor 16, then a new tubular segment (e.g., tubular, tubular stand, etc.) can be added to the tubular string 58 by retrieving a tubular segment 50, 54 from tubular storage via a pipe handler, stop mud flow and disconnect the top drive from the tubular string 58, hold the tubular string 58 in place via the slips at well center, raise the top drive 18 to provide clearance for the tubular segment to be added, transfer tubular segment 50, 54 from the pipe handler 30 to the top drive 18, connect the tubular segment 50, 54 to the top drive 18, lower the tubular segment 50, 54 to the stump of the tubular string 58 and connect it to the tubular string 58 using a roughneck to torque the connection, then start mud flow. This can be performed each time the top end of the tubular string 58 is lowered below “WW” ft above the rig floor 16.

At task 120.6, add tubular segments 50, 54 to the tubular string 58 as needed in task 120.5 to drill wellbore 15 to a depth of 150 ft. Stop rotation of the drill bit 68 and stop mud pumps 84.

At task 120.7, perform a deviation survey by reading the inclination data from the BHA 60, comparing the inclination data to expected inclination data, and report deviations from the expected. Correct drilling parameters if deviations are greater than a pre-determined limit.

The conversion from a well plan 100 to a rig-specific rig plan 102 can be performed manually or automatically with the best practices and equipment recipes known for the rig that can be used in the wellbore construction.

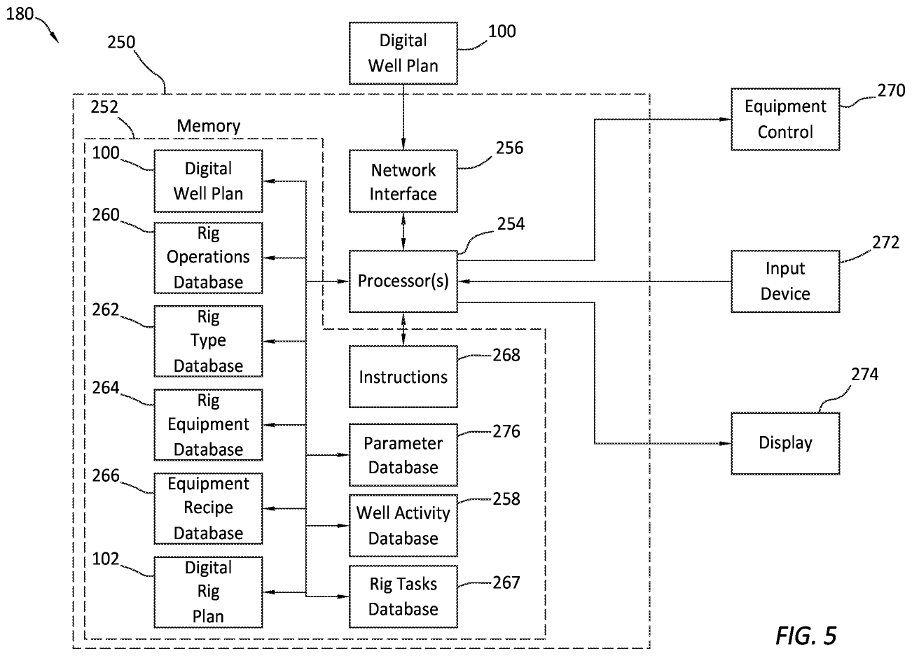

FIG. 5 is a representative functional diagram of the conversion engine 180 that can include possible databases used by a rig controller 250 to convert a digital well plan to a digital rig plan. The conversion engine 180 can be a program (i.e., list of instructions 268) that can be stored in the non-transitory memory 252 and executed by processor(s) 254 of the rig controller 250 to convert a digital well plan 100 to a digital rig plan 102.

A digital well plan 100 can be received at an input to the rig controller 250 via a network interface 256. The digital well plan 100 can be received by the processor(s) 254 and stored in the memory 252. The processor(s) 254 can then begin reading the sequential list of well plan activities 170 of the digital well plan 100 from the memory 252. The processor(s) 254 can process each well plan activity 170 to create rig-specific tasks to implement the respective activity 170 on a specific rig (e.g., rig 10).

To convert each well plan activity 170 to rig-specific activities for a rig 10, processor(s) 254 must determine the equipment available on the rig 10, the best practices, operations, and parameters for running each piece of equipment, and the operations to be run on the rig to implement each of the well plan activities 170.

Referring again to FIG. 5, the processor(s) 254 are communicatively coupled to the non-transitory memory 252 which can store multiple databases for converting the well plan 100 into the rig plan 102. A rig operations database 260 includes rig operations for implementing each of the well plan activities 170. Each of the rig operations can include one or more tasks to perform the rig operation. The processor(s) 254 can retrieve those operations for implementing the first rig activity 170 from the rig operations database 260 including the task lists for each operation. The processor(s) 254 can receive a rig type RT from a user input or the network interface 256. With the rig type RT, the processor(s) 254 can retrieve a list of equipment available on the rig 10 from the rig type database 262, which can contain equipment lists for a plurality of rig types.

The processor(s) 254 can then convert the operation tasks to rig-specific tasks to implement the operations on the rig 10. The rig-specific tasks can include the appropriate equipment for rig 10 to perform the operation task. The processor(s) 254 can then collect the recipes for operating each of the available equipment for rig 10 from the recipes database 266, where the recipes can include best practices on operating the equipment, preferred parameters for operating the equipment, and operational tasks for the equipment (such as turn ON procedures, ramp up procedures, ramp down procedures, shutdown procedures, etc.). The rig controller 250 can also retrieve parameters for the recipes from a separate parameters database 276, where these parameters can be the preferred parameters for operating the rig equipment using the recipes from the recipes database 266.

Therefore, the processor(s) 254 can retrieve each of the well plan activities 170 and convert them to a list of rig-specific tasks that can perform the respective well plan activity 170 on the rig 10. After converting all of the well plan activities 170 to rig specific tasks 190 and creating a sequential list of the tasks 190, the processor(s) 254 can store the resulting digital rig plan 102 in the memory 252. When the rig 10 is operational and positioned at the proper location to drill a wellbore 15, the rig controller 250, via the processor(s) 254, can begin executing the list of tasks in the digital rig plan 102 by sending control signals and messages to the equipment control 270.

The well plan 100 received initially at the rig controller 250 can include alternate activities that can be selected by the rig controller 250 or an individual 4 to manage a dysfunction that was understood by the designers of the well plan to be highly likely in the execution of the well plan 100 (i.e., a planned predictive dysfunction). These activities can be included in the well plan 100 with the other well plan activities 170 and the well plan 100 is converted to the rig-specific digital rig plan 102. The corresponding rig tasks 190 for these alternative activities can be embedded in the digital rig plan 102 to be available in case the planned predictive dysfunction occurs.

The rig controller 250 can also convert additional well plan activities via the same process when it receives the additional well plan activities during execution of the digital rig plan (e.g., to manage unplanned dysfunctions as they occur (reactive) or prior to their occurrence (predictive)). Additionally, the rig controller 250 can include databases of pre-planned activities and tasks that can be used to perform additional well activities that may arise during execution of the digital rig plan 102. For example, the well activity database 258 can include pre-planned activities for performing desired processes or actions, such as tripping in a tubular string, tripping out a tubular string, clean well, reem well, perform wellbore tests, etc. Therefore, if the rig controller 250 needs to perform a desired process or action, then the rig controller 250 can select the one or more well activities from the database 258, convert the one or more well activities to rig-specific tasks, and inject the rig-specific tasks into the current digital rig plan 102.

It should be understood that to perform a desired process or action, the rig controller 250 can also retrieve from a rig tasks database 267 a list of rig-specific tasks that have already been converted from well activities and stored in the rig tasks database 267. This allows the rig controller 250 to bypass the conversion process when adding new tasks to the digital rig plan when the database 267 already contains the task list for performing the desired process or action that was not originally included in the well plan 100 near the current activity in the current well plan 100.

There can also be multiple well activities or lists of rig tasks that can perform the desired process or action on the rig 10. Therefore, the rig controller 250 can use a performance index associated with each of the well activities or lists of rig tasks to determine which might be the best choice for performing the desired process or action on the rig. The rig controller 250 can update the performance index each time the well activity or list of rig tasks are used and therefore, continually update the performance indices. The list of rig tasks in the rig task database can also include the preferred parameters and best practices for operating the rig equipment.

The rig controller 250 can also receive user input from an input device 272 or display information to a user or individual 4 via a display 274. The input device 272 in cooperation with the display 274 can be used to input well plan activities, initiate processes (such as converting the digital well plan 100 to the digital rig plan 102), select alternative activities, or rig tasks during execution of digital well plan 100 or digital rig plan 102, or monitor operations during well plan execution.

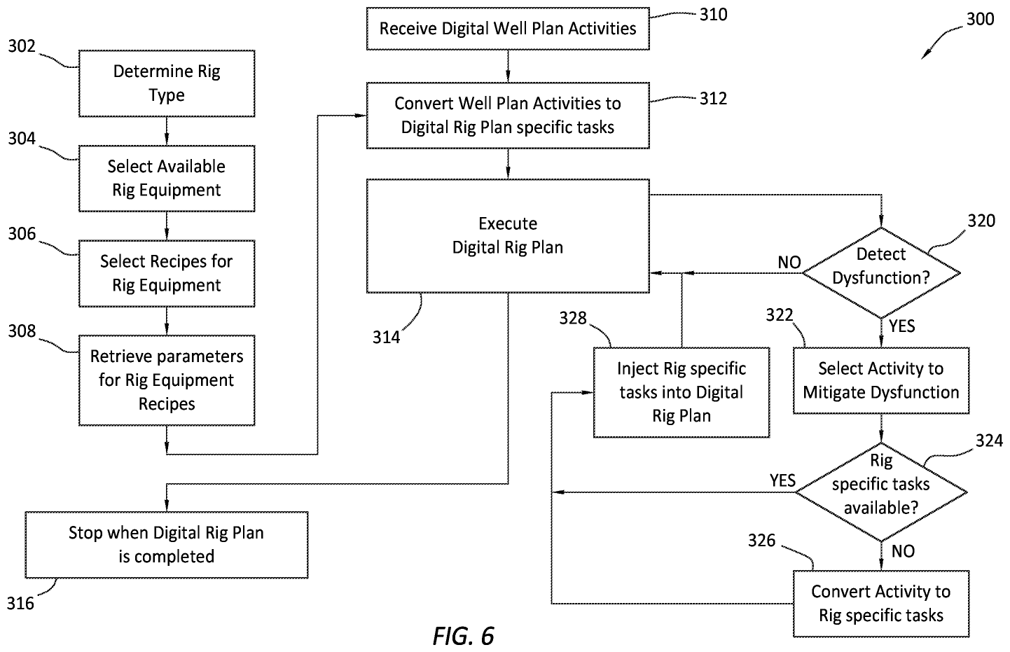

FIG. 6 is a representative functional diagram that illustrates a method 300 for converting a digital well plan 100 to a digital rig plan 102 and mitigating a detected dysfunction while executing the digital rig plan 102. At operation 310, the rig controller 250 can receive the activities from the digital well plan 100. At operation 302, the rig controller 250 can receive the rig type RT, and in operation 304 use the rig type to select the list of available rig equipment from the rig type database 262. In operation 306, the rig controller 250 can retrieve recipes for operating the available rig equipment from the recipes database 266. In operation 308, the rig controller 250 can retrieve operating parameters for the recipes from the recipes database 266 or from a separate parameters database 276. In operation 312, the rig controller 250 can use the available rig equipment for the rig type and the recipes for operating the available rig equipment to convert the digital well plan 100 activities 170 to digital rig plan 102 tasks 190 along with operations collected from the rig operations database 260 for performing each activity 170.

In operation 314, the rig controller 250 can begin executing the digital rig plan 102. During execution of the digital rig plan 102, the rig controller 250 can continuously (or at least periodically or on an as needed basis) receive data from the multiple data sources and aggregate the data to determine the current state of the rig operations, the current activity of the well plan 100 being performed, the current rig task being performed, the adherence of the current well activity to track the expected performance of the digital well plan 100. For example, if the current well activity is a planned well activity or an unplanned or unexpected well activity at the current time. In operation 320, the rig controller 250 can monitor the health of the rig operations and detect a dysfunction that may be occurring or will occur in the near future. If a dysfunction is not detected, then the execution of the digital rig plan 102 can continue with the rig controller 250 proceeding back to operation 314. However, if a dysfunction is detected, then the rig controller 250 can proceed to operation 322.

In operation 322, the rig controller 250 can select one or more well activities 170 that can be used to mitigate (or manage) the dysfunction so the rig controller 250 can return to executing the digital rig plan 102 once the dysfunction is mitigated. It should be noted that the one or more well activities 170 can be pre-planned well activities 170 that were included in the initial digital well plan 100 prior to conversion to the digital rig plan 102. Therefore, the rig-specific tasks 190 for implementing the pre-planned well activities 170 can already be available in the digital rig plan 102. Therefore, the rig controller 250 (or individual 4) can initiate execution of the rig-specific tasks 190 for implementing the pre-planned well activities 170. As mentioned above, this can be seen as a planned predictive dysfunction that was initially anticipated.

If the detected dysfunction was not a planned predictive dysfunction, then it may possibly be an unplanned predictive dysfunction or an unplanned reactive dysfunction. If the dysfunction is an unplanned predictive dysfunction, then the rig controller 250 (or individual 4) can select one or more well activities 170 to mitigate the dysfunction. In operation 322, the rig controller 250 can check to see if there are already rig-specific tasks 190 in the rig tasks database 267 to implement the one or more well activities 170. If so, the rig controller 250 can inject the rig-specific tasks 190 (in operation 328) into the digital rig plan 102 for execution in operation 314. If not, the rig controller 250 can convert the one or more well activities 170 to rig specific tasks 190 (in operation 326) and inject the rig specific tasks 190 (in operation 328) into the digital rig plan 102 for execution in operation 314. However, injecting the rig-specific tasks 190 into the digital rig plan 102 does not require the rig controller 250 to immediately begin execution of the rig-specific tasks 190 to mitigate the dysfunction, since the dysfunction is an unplanned predictive dysfunction. The rig controller 250 can determine the best time to mitigate the dysfunction by selecting a start time for the execution of the rig-specific tasks 190 for mitigating the dysfunction. The rig controller 250 can continue to execute the digital rig plan 102 in operation 314 until the desired time (or start time) to mitigate the unplanned predictive dysfunction has come.

If the dysfunction is an unplanned reactive dysfunction, then the rig controller 250 (or individual 4) can select one or more well activities 170 to mitigate the dysfunction. In operation 322, the rig controller 250 can check to see if there are already rig-specific tasks 190 in the rig tasks database 267 to implement the one or more well activities 170. If so, the rig controller 250 can inject the rig-specific tasks 190 (in operation 328) into the digital rig plan 102 for execution in operation 314. If not, the rig controller 250 can convert the one or more well activities 170 to rig specific tasks 190 (in operation 326) and inject the rig specific tasks 190 (in operation 328) into the digital rig plan 102 for execution in operation 314. For this kind of dysfunction, execution of the digital rig plan 102 may already be impacted, so more often than not, the rig controller 250 may begin executing the rig specific tasks 190 for mitigating the dysfunction as soon as they are injected into the digital rig plan 102 in operation 328. When the digital rig plan 102 is completed and the wellbore 15 is drilled to its target depth TD, then the drilling operations on the rig 10 can stop in operation 316.

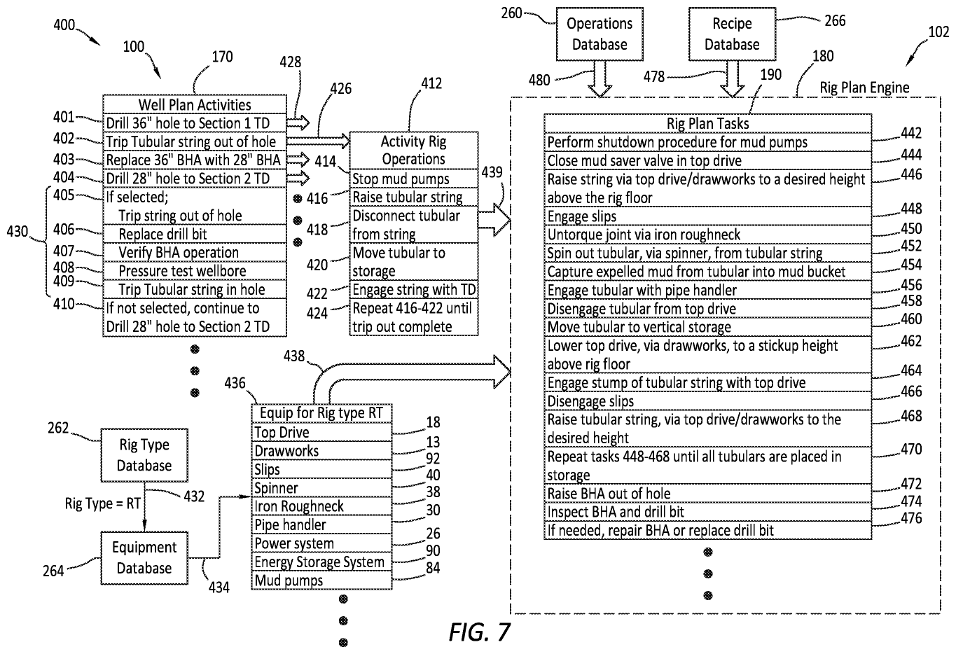

FIG. 7 is a representative functional diagram that illustrates a method 400 for using a conversion engine 180 and databases (e.g., 260, 262, 264, 266) to convert a digital well plan 100 to a digital rig plan 102, with the digital well plan 100 including alternate activities for managing a dysfunction. The rig controller 250 can receive the well plan activities 170 of the digital well plan 100 and retrieve 428 rig operations for performing each activity 170 (e.g., 401-410). The resulting group of rig operations can be converted, via the rig plan engine (possibly running on the rig controller 250), into the rig plan tasks 190 of the digital rig plan 102. As way of example, the well activity 402 can be converted to a list of rig operations 412 which are more detailed operations for performing the activity 402.

For example, the activity 402 may request to trip a tubular string 58 out of the hole (or wellbore 15). This request can require the more detailed operations (list 412) to perform the requested activity 402. For example, the list of rig operations 412 can include operation 414 which can stop the pumps 84 in preparation for disconnecting a tubular 50, 54 from the tubular string 58. Operation 416 can raise the tubular string 58, via the top drive 18, to a desired height that will allow disconnection and removal of the tubular 50, 54 from the tubular string 58. In operation 418, the iron roughneck 38 can be used to untorque the joint where the tubular 50, 54 is connected to the tubular string 58 and spin the tubular 50, 54 from the tubular string 58. In operation 420, a pipe handler 30 can collect the tubular 50, 54 from either the iron roughneck 38 or the top drive 18 and move the tubular 50, 54 to a storage location (e.g., vertical storage 36 or horizontal storage 56). In operation 422, the top drive may then be lowered to engage the stump of the tubular string 58 (which can be sticking out just above the rig floor 16 at well center). As stated in operation 424, operations 416 thru 422 can be repeated as needed until the tubular string 58 has been tripped out of the hole (or wellbore 15). The lists of rig operations (e.g., list 412) can be input into the conversion engine 180 for conversion to the rig plan tasks 190 of the rig plan 102 for constructing a desired wellbore 15 using the rig 10.

The rig controller 250 can receive the rig type RT and based on the rig type RT identify which of the rig equipment in the equipment database 264 are available on the rig 10. An example of the available equipment for rig 10 based on the rig type RT is shown in the equipment list 436. These are only examples of equipment that may be included with rig 10, but it should be understood that this disclosure is not limited to the equipment listed in the list 436. More or fewer pieces of equipment can be available for rig 10. The list of available equipment 436 can also be input into the conversion engine 180 for conversion to the rig plan tasks 190 of the rig plan 102 for constructing a desired wellbore 15 using the rig 10.

As stated above, the conversion engine 180 can use the rig operations (e.g., list 412), the list of available rig equipment 436, and the recipe database 266 to convert the rig operations into the rig plan tasks 190 for implementing the rig operations on the rig 10. This can be done initially when the original digital well plan 100 is converted into the digital rig plan 102, or it can be done after the execution of the digital rig plan 102 has begun, and, for example, a dysfunction is detected. In this case, the well plan activities can be those activities needed to mitigate the dysfunction. The conversion engine 180 can also collect operations directly from the operations database 260 to be converted into rig plan tasks 190, for example, to mitigate detected dysfunctions.

In the current example illustrated in FIG. 7, the list 412 of rig operations 414 thru 424 can be converted into the rig plan tasks 442 thru 476. It should be understood that this list of rig tasks 190 for performing the list of operations 412 are merely examples of the tasks that can be used. More or fewer tasks can be used to perform this list of operations 412.

### Various Embodiments

Embodiment 1. A method for performing a subterranean operation comprising: receiving, at a rig controller, a digital well plan comprising tool non-specific operations; converting the digital well plan to a digital rig plan, the digital rig plan comprising a plurality of first task lists of tool-specific tasks for a specific rig, with each one of the plurality of first task lists performing at least one of the tool non-specific operations;

inserting into the digital rig plan, via a rig controller, at least one alternative list of tool-specific tasks for performing at least one alternative operation;

during execution of the digital rig plan, selecting, via the rig controller, the at least one alternative list of tool-specific tasks; and

performing, at the specific rig, the at least one alternative list of tool-specific tasks in response to the selecting.

Embodiment 2. The method of embodiment 1, further comprising inserting the at least one alternative list of tool-specific tasks into the digital rig plan prior to when the execution of the digital rig plan has begun.

Embodiment 3. The method of embodiment 2, further comprising:

detecting, via the rig controller, a dysfunction; and

via the rig controller, automatically selecting execution of the at least one alternative list of tool-specific tasks based on the detecting.

Embodiment 4. The method of embodiment 3, wherein the dysfunction comprises one of a stuck pipe, lost circulation of fluid, fluid influx, high torque in a tubular string, high drag on the tubular string, equipment failure, equipment wear, reduced rate of penetration of tubular string, unexpected changes in layers of an earthen formation, and combinations thereof.

Embodiment 5. The method of embodiment 2, further comprising:

detecting, via the rig controller, a dysfunction;

receiving an input from a user or another controller at the rig controller; and

via the rig controller, initiating execution of the at least one alternative list of tool-specific tasks based on the input.

Embodiment 6. The method of embodiment 2, further comprising: receiving an input from a user or another controller at the rig controller; and via the rig controller, initiating execution of the at least one alternative list of tool-specific tasks based on the input.

Embodiment 7. The method of embodiment 1, further comprising inserting the at least one alternative list of tool-specific tasks into the digital rig plan after execution of the digital rig plan has begun.

Embodiment 8. The method of embodiment 7, further comprising:

detecting a dysfunction during execution of the digital rig plan; and

identifying the at least one alternative operation as one or more operations for managing the dysfunction.

Embodiment 9. The method of embodiment 8, wherein the identifying further comprises identifying the at least one alternative operation based on a performance index for managing the dysfunction, with the performance index for the at least one alternative operation being higher than other alternative operations for managing the dysfunction.

Embodiment 10. The method of embodiment 8, further comprising:

prior to execution of the digital rig plan, converting the at least one alternative operation into the at least one alternative list of tool-specific tasks; and

during execution of the digital rig plan, inserting the at least one alternative list of tool-specific tasks into the digital rig plan.

Embodiment 11. The method of embodiment 8, further comprising:

during execution of the digital rig plan, converting the at least one alternative operation into the at least one alternative list of tool-specific tasks; and

during execution of the digital rig plan, inserting the at least one alternative list of tool-specific tasks into the digital rig plan.

Embodiment 12. The method of embodiment 11, further comprising:

executing, via the rig controller, the at least one alternative list of tool-specific tasks, thereby managing the dysfunction and returning execution of the digital rig plan, via the rig controller, to execution of a remaining portion of the plurality of first task lists.

Embodiment 13. The method of embodiment 7, further comprising:

predicting a future dysfunction during execution of the digital rig plan; and

identifying the at least one alternative operation as an operation for managing the future dysfunction.

Embodiment 14. The method of embodiment 13, wherein the identifying further comprises identifying the at least one alternative operation based on a performance index for managing the future dysfunction, with the performance index for the at least one alternative operation being higher than other alternative operations for managing the future dysfunction.

Embodiment 15. The method of embodiment 13, further comprising: during execution of the digital rig plan, converting the at least one alternative operation into the at least one alternative list of tool-specific tasks; and during execution of the digital rig plan, inserting the at least one alternative list of tool-specific tasks into the digital rig plan.

Embodiment 16. The method of embodiment 15, further comprising:

via the rig controller, selecting execution of the at least one alternative list of tool-specific tasks prior to the future dysfunction occurring.

Embodiment 17. The method of embodiment 16, further comprising:

executing, via the rig controller, the at least one alternative list of tool-specific tasks, thereby bypassing the future dysfunction and returning execution of the digital rig plan, via the rig controller, to execution of a remaining portion of the plurality of first task lists.

Embodiment 18. A method for performing a subterranean operation comprising:

receiving, at a rig controller, a digital well plan that comprises a set of rig activities for a rig;

retrieving a set of sequence blocks from a rig activity database for each of the rig activities, wherein each sequence block comprises a set of operations to be performed to execute the sequence block, and wherein at least one of the sequence blocks comprises a first alternative set of operations which is selectable during execution of the digital well plan;

receiving, at a rig controller, a rig type of the rig;

retrieving, via the rig controller, a set of rig equipment from a rig equipment database based on the rig type;

retrieving a first task list of tool-specific tasks for each piece of rig equipment in the set of rig equipment, thereby creating a plurality of first task lists; and

converting the sequence blocks of the digital well plan to a digital rig plan that comprises a second task list of tool-specific tasks to implement the digital well plan, wherein the second task list comprises a listing of the plurality of first task lists, and wherein the plurality of first tasks lists comprises one or more third task lists to implement the first alternative set of operations.

Embodiment 19. The method of embodiment 18, further comprising during execution of the digital rig plan, selecting, via the rig controller, the one or more third task lists to execute the first alternative set of operations.

Embodiment 20. The method of embodiment 18, wherein a rig type database comprises one or more rig types, and wherein each of the one or more rig types identifies a list of equipment from the rig equipment database, the list of equipment being associated with the respective rig type.

Embodiment 21. The method of embodiment 18, further comprising, retrieving a recipe from a recipe database for each piece of the rig equipment in the set of rig equipment.

Embodiment 22. The method of embodiment 21, wherein each one of the recipes comprises parameters, operating instructions, or combinations thereof for a respective piece of the rig equipment.

Embodiment 23. The method of embodiment 18, further comprising:

detecting, via the rig controller, a dysfunction; and

via the rig controller, automatically selecting execution of the one or more third task lists based on the detecting.

Embodiment 24. The method of embodiment 23, wherein the dysfunction comprises one of a stuck pipe, lost circulation of fluid, fluid influx, high torque in a tubular string, high drag on the tubular string, equipment failure, equipment wear, reduced rate of penetration of tubular string, unexpected changes in layers of an earthen formation, and combinations thereof.

Embodiment 25. The method of embodiment 18, further comprising:

detecting, via the rig controller, a dysfunction;

receiving an input from a user or another controller at the rig controller; and via the rig controller, initiating execution of the one or more third task lists based on the input.

Embodiment 26. The method of embodiment 18, further comprising: receiving an input from a user or another controller at the rig controller; and via the rig controller, initiating execution of the one or more third task lists based on the input.

Embodiment 27. The method of embodiment 18, wherein at least one of the sequence blocks comprises a second alternative set of operations which is selectable during execution of the digital well plan, and wherein the plurality of first tasks lists comprises one or more fourth task lists to implement the second alternative set of operations.

Embodiment 28. The method of embodiment 27, further comprising:

inserting the one or more fourth task lists into the digital rig plan prior to when execution of the digital rig plan has begun.

Embodiment 29. The method of embodiment 28, further comprising:

detecting, via the rig controller, a dysfunction; and

via the rig controller, automatically selecting execution of the one or more fourth task lists based on the detecting.

Embodiment 30. The method of embodiment 28, further comprising:

detecting, via the rig controller, a dysfunction;

receiving user input at the rig controller; and

via the rig controller, initiating execution of the one or more fourth task lists based on the user input.

Embodiment 31. The method of embodiment 28, further comprising:

receiving user input at the rig controller; and

via the rig controller, initiating execution of the one or more fourth task lists based on the user input.

Embodiment 32. The method of embodiment 27, further comprising inserting the one or more fourth task lists into the digital rig plan after execution of the digital rig plan has begun.

Embodiment 33. The method of embodiment 32, further comprising:

detecting a dysfunction during execution of the digital rig plan; and

identifying the second alternative set of operations as one or more operations for managing the dysfunction.

Embodiment 34. The method of embodiment 33, wherein the identifying further comprises identifying the second alternative set of operations based on a performance index for managing the dysfunction, with the performance index for the second alternative set of operations being higher than other alternative operations for managing the dysfunction.

Embodiment 35. The method of embodiment 33, further comprising:

prior to execution of the digital rig plan, converting the second alternative set of operations into the one or more fourth task lists; and

during execution of the digital rig plan, inserting the one or more fourth task lists into the digital rig plan.

Embodiment 36. The method of embodiment 33, further comprising:

during execution of the digital rig plan, converting the second alternative set of operations into the one or more fourth task lists; and

during execution of the digital rig plan, inserting the one or more fourth task lists into the digital rig plan.

Embodiment 37. The method of embodiment 36, further comprising:

executing, via the rig controller, the one or more fourth task lists, thereby managing the dysfunction and returning execution of the digital rig plan, via the rig controller, to execution of a remaining portion of the plurality of first task lists.

Embodiment 38. The method of embodiment 32, further comprising:

predicting a future dysfunction during execution of the digital rig plan; and

identifying the second alternative set of operations as one or more operations for managing the future dysfunction.

Embodiment 39. The method of embodiment 38, wherein the identifying further comprises identifying the second alternative set of operations based on a performance index for managing the future dysfunction, with the performance index for the second alternative set of operations being higher than other alternative operations for managing the future dysfunction.

Embodiment 40. The method of embodiment 38, further comprising:

during execution of the digital rig plan, converting the second alternative set of operations into the one or more fourth task lists; and

during execution of the digital rig plan, inserting the one or more fourth task lists into the digital rig plan.

Embodiment 41. The method of embodiment 40, further comprising:

via the rig controller, selecting execution of the one or more fourth task lists prior to the future dysfunction occurring.

Embodiment 42. The method of embodiment 41, further comprising:

executing, via the rig controller, the one or more fourth task lists, thereby bypassing the future dysfunction and returning execution of the digital rig plan, via the rig controller, to execution of a remaining portion of the plurality of first task lists.

Embodiment 43. A system configured to carry out any of the methods claimed herein.

While the present disclosure may be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

1. A method for performing a subterranean operation comprising:
receiving, at a rig controller, a digital well plan comprising tool non-specific operations;
converting the digital well plan to a digital rig plan, the digital rig plan comprising a plurality of first task lists of tool-specific tasks for a specific rig, with each one of the plurality of first task lists performing at least one of the tool non-specific operations;
inserting into the digital rig plan, via the rig controller, at least one alternative list of tool-specific tasks for performing at least one alternative operation;
during execution of the digital rig plan, selecting, via the rig controller, the at least one alternative list of tool-specific tasks; and
performing, at the specific rig, the at least one alternative list of tool-specific tasks in response to the selecting.

2. The method of claim 1, further comprising inserting the at least one alternative list of tool-specific tasks into the digital rig plan prior to when execution of the digital rig plan has begun.

3. The method of claim 2, further comprising:
detecting, via the rig controller, a dysfunction; and
via the rig controller, automatically selecting execution of the at least one alternative list of tool-specific tasks based on the detecting.

4. The method of claim 2, further comprising:
detecting, via the rig controller, a dysfunction;
receiving user input at the rig controller; and
via the rig controller, initiating execution of the at least one alternative list of tool-specific tasks based on the user input.

5. The method of claim 1, further comprising inserting the at least one alternative list of tool-specific tasks into the digital rig plan after execution of the digital rig plan has begun.

6. The method of claim 5, further comprising:
detecting a dysfunction during execution of the digital rig plan; and
identifying the at least one alternative operation as one or more operations for managing the dysfunction.

7. The method of claim 6, wherein the identifying further comprises identifying the at least one alternative operation based on a performance index for managing the dysfunction, with the performance index for the at least one alternative operation being higher than other alternative operations for managing the dysfunction.

8. The method of claim 5, further comprising:
predicting a future dysfunction during execution of the digital rig plan; and
identifying the at least one alternative operation as an operation for managing the future dysfunction.

9. The method of claim 8, wherein the identifying further comprises identifying the at least one alternative operation based on a performance index for managing the future dysfunction, with the performance index for the at least one alternative operation being higher than other alternative operations for managing the future dysfunction.

10. The method of claim 8, further comprising:
during execution of the digital rig plan, converting the at least one alternative operation into the at least one alternative list of tool-specific tasks; and
during execution of the digital rig plan, inserting the at least one alternative list of tool-specific tasks into the digital rig plan.

11. A method for performing a subterranean operation comprising:
receiving a digital well plan that comprises a set of rig activities for a rig;
retrieving a set of sequence blocks from a rig activity database for each of the rig activities, wherein each sequence block comprises a set of operations to be performed to execute the sequence block, and wherein at least one of the sequence blocks comprises a first alternative set of operations which is selectable during execution of the digital well plan;
receiving, at a rig controller, a rig type of the rig;
retrieving, via the rig controller, a set of rig equipment from a rig equipment database based on the rig type;
retrieving a first task list of tool-specific tasks for each piece of rig equipment in the set of rig equipment, thereby creating a plurality of first task lists; and
converting the sequence blocks of the digital well plan to a digital rig plan that comprises a second task list of tool-specific tasks to implement the digital well plan, wherein the second task list comprises a listing of the plurality of first task lists, and wherein the plurality of first tasks lists comprises one or more third task lists to implement the first alternative set of operations.

12. The method of claim 11, further comprising:
detecting, via the rig controller, a dysfunction; and
via the rig controller, automatically selecting execution of the one or more third task lists based on the detecting.

13. The method of claim 11, further comprising:
detecting, via the rig controller, a dysfunction;
receiving user input at the rig controller; and
via the rig controller, initiating execution of the one or more third task lists based on the user input.

14. The method of claim 11, wherein at least one of the sequence blocks comprises a second alternative set of operations which is selectable during execution of the digital well plan, and wherein the plurality of first tasks lists comprises one or more fourth task lists to implement the second alternative set of operations.

15. The method of claim 14, further comprising:
inserting the one or more fourth task lists into the digital rig plan prior to when execution of the digital rig plan has begun;
detecting, via the rig controller, a dysfunction; and
via the rig controller, automatically selecting execution of the one or more fourth task lists based on the detecting.

16. The method of claim 14, further comprising inserting the one or more fourth task lists into the digital rig plan after execution of the digital rig plan has begun.

17. The method of claim 16, further comprising:
detecting a dysfunction during execution of the digital rig plan; and
identifying the second alternative set of operations as one or more operations for managing the dysfunction, wherein the identifying further comprises identifying the second alternative set of operations based on a performance index for managing the dysfunction, with the performance index for the second alternative set of operations being higher than other alternative operations for managing the dysfunction.

18. The method of claim 16, further comprising:
predicting a future dysfunction during execution of the digital rig plan; and
identifying the second alternative set of operations as one or more operations for managing the future dysfunction, wherein the identifying further comprises identifying the second alternative set of operations based on a performance index for managing the future dysfunction, with the performance index for the second alternative set of operations being higher than other alternative operations for managing the future dysfunction.

19. The method of claim 18, further comprising:
during execution of the digital rig plan, converting the second alternative set of operations into the one or more fourth task lists; and
during execution of the digital rig plan, inserting the one or more fourth task lists into the digital rig plan.

20. The method of claim 19, further comprising:
via the rig controller, selecting execution of the one or more fourth task lists prior to the future dysfunction occurring; and
executing, via the rig controller, the one or more fourth task lists, thereby bypassing the future dysfunction and returning execution of the digital rig plan, via the rig controller, to execution of a remaining portion of the plurality of first task lists.
